(19) United States
(12) Patent Application Publication
(10) Pub. No.: US 2008/0106969 A1
(43) Pub. Date: May 8, 2008

(54) FLUID MIXER AND MIXING ELEMENT MEMBER

(75) Inventor: Hisao KOJIMA, Yokohama-shi (JP)

Correspondence Address: DITTHAVONG MORI & STEINER, P.C., 918 Prince St., Alexandria, VA, 22314, US

(73) Assignee: Anemos Company Ltd., Tokyo (JP)

(21) Appl. No.: 11/932,584

(22) Filed: Oct. 31, 2007

(30) Foreign Application Priority Data
Nov. 2, 2006 (JP) 2006-299497

(51) Int. Cl. B01F 15/02

(52) U.S. Cl. 366/134; 366/155.1

(57) ABSTRACT

Disclosed is a fluid mixer to mix different fluids, the fluid mixer that includes a top section and a holder section. The top section has a plurality of inlets and a mixing portion communicates with the plurality of inlets. The holder section has a discharge portion that communicates with the mixing portion through a passage and a mixing member to mix the different fluids in the middle of the passage.

### CROSS REFERENCES TO RELATED APPLICATIONS

The present invention contains subject matter related to Japanese Patent Application JP 2006-299467 filed in the Japanese Patent Office on Nov. 2, 2006, the entire contents of which being incorporated herein by reference.

### BACKGROUND OF THE INVENTION

1. Field of the Invention

The present invention relates to a fluid mixer to mix, stir, emulsify, disperse, dissolve, diffuse, and chemically react different types of fluids. The present invention relates to a fluid mixer to mix fluids such as a main agent and a curing agent, for example.

2. Description of the Related Art

Domestic Re-publication of PCT International Application 2000-24502 discloses a static fluid mixer of the related art to perform in-line mixing of different types of fluids, where a plurality of mixing elements are placed in a passage structure (casing) corresponding to a pipe, for example.

FIG. 1 shows a schematic cross-sectional view of a fluid mixer of the related art.

In a mixing mechanism of the fluid mixer 100, when a fluid is caused to flow into a casing 120 from one inlet passage 122 formed in a cover 121, the fluid reaches the inside of a mixing element 101 from a passage hole 105 of the mixing element 101 and radially flows from the center to the outside through mixing chambers 108 and 113 communicating with each other. The fluid having reached the inner periphery of the casing 120 enters the passage hole 105 of the mixing element 101 from a passage 115 through the mixing chambers 108 and 113 on the downstream side. Thereafter, the fluid sequentially flows in a plurality of the mixing elements and is discharged from an outlet 123.

### SUMMARY OF THE INVENTION

However, in the fluid mixer 100 of the related art, when different types of fluids are mixed in the mixing element 101, it is necessary to previously mix the different types of fluids and then cause the mixture to flow into the casing 120 from the inlet 122. Therefore, when a fast-curing fluid such as a curing agent is used, for example, the curing agent or the like is cured during flowing in the inlet passage 122 formed in the cover 121 and thus may not be mixed in the mixing element 101, disadvantageously.

In addition, since a fluid is cured in the inlet passage 122, a fresh fluid may not be supplied and the fluid mixer may not be used, disadvantageously.

According to an embodiment of the present invention, there is provided a fluid mixer and a mixing element member in which different types of fluids may be efficiently mixed.

Attempts have been made to achieve the above object, and the object is achieved by the following inventions (1) to (11).

(1) A fluid mixer to mix different fluids, the fluid mixer including:
a top section and a holder section,
the top section having a plurality of inlets and a mixing portion communicating with the plurality of inlets, and
the holder section having a discharge portion communicating with the mixing portion through a passage and a mixing member to mix the different fluids in the middle of the passage.

(2) The fluid mixer according to (1) above, where
the mixing portion is provided near the mixing member.

(3) The fluid mixer according to (1) above, where
the top section is hemispherically formed.

(4) The fluid mixer according to (1) above,
where a universal joint member is detachably engaged with the inlet.

(5) The fluid mixer according to (1) or (2) above, where
a universal joint member is detachably engaged with the discharge portion.

(6) The fluid mixer according to (1) above, where
the mixing member is formed by a combination of a plurality of mixing element members having an identical structure.

(7) The fluid mixer according to (6) above, where
the mixing element members each have a passage hole through which the different fluids are allowed to pass and a divider having a spiral shape formed in the passage hole.

(8) The fluid mixer according to (7) above, wherein
the passage hole has a diameter of 0.5 mm to 10.0 mm.

(9) A mixing element member that forms a mixing member used in a fluid mixer to mix different fluids, the mixing element member including:
a passage hole through which the fluids are allowed to pass and a divider having a spiral shape formed in the passage hole.

(10) The mixing element member according to (9) above, where
the mixing element member has a recess and projection portion to fit the mixing element member with another mixing element member having an identical structure.

(11) The mixing element member according to (9) above, where
the passage hole has a diameter of 0.5 mm to 10.0 mm.

According to the fluid mixer of an embodiment according to the present invention, since different types of fluids are supplied to the mixing member using separate passages, the fluids are not cured in the passages and may be efficiently mixed.

According to the mixing element member of an embodiment of the present invention, since different types of fluids are efficiently mixed in the divider, the fluids passing through the mixing member may be mixed at an increased mixing rate.

### BRIEF DESCRIPTION OF THE DRAWINGS

FIG. 1 is a cross-sectional view showing a fluid mixer of the related art.

FIG. 2 is an oblique view of a fluid mixer according to an embodiment of the present invention.

FIG. 3 is an exploded oblique view of a fluid mixer according to an embodiment of the present invention.

FIG. 4 is a plan view of a top section used in the present embodiment viewed from the side of a bottom surface.

FIG. 5 is a plan view of a holder section used in the present embodiment viewed from the side of a head portion.

FIG. 6 is an oblique cross-sectional view of a fluid mixer according to an embodiment of the present invention.

FIG. 7 is an oblique view of a mixing element member that forms a mixing member used in the fluid mixer of the present embodiment.

FIG. 8 is an oblique view of a fluid mixer according to another embodiment of the present invention.

FIG. 9 is an oblique view of a fluid mixer according to another embodiment of the present invention.

FIG. 10 is an oblique view of a fluid mixer according to another embodiment of the present invention.

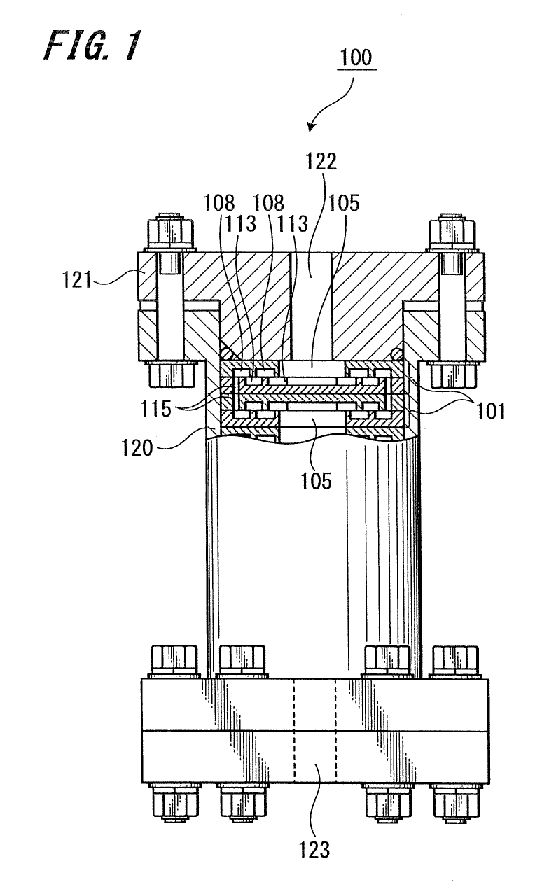

### DESCRIPTION OF THE PREFERRED EMBODIMENTS

An embodiment of the fluid mixer of the present invention will be described with reference to the drawings; however, the present invention is not limited to the following embodiment. The mixing element member of an embodiment according to the present invention will also be described together with the fluid mixer.

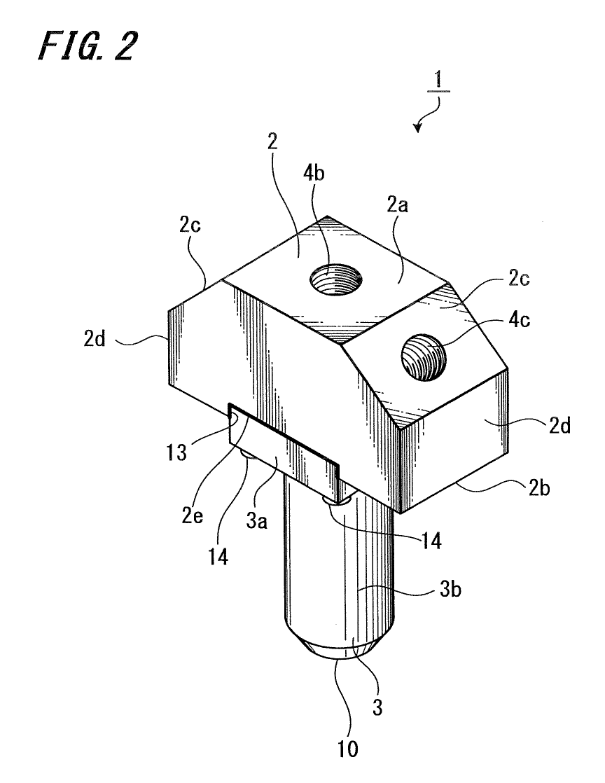

FIG. 2 shows an oblique view of a fluid mixer according to an embodiment of the present invention.

As shown in FIG. 2, the fluid mixer 1 according to the present embodiment is formed by a top section 2 and a holder section 3.

The top section 2 has a shape in which a slope of a solid trapezoid member is cut at right angles to a bottom surface. In the top section 2 are formed an upper surface 2a; a bottom surface 2b; side surfaces 2c opposed to each other with respect to a center cutting-plane line between the upper surface 2a and the bottom surface 2b; and side surfaces 2d opposed to each other with respect to the center cutting-plane line between the upper surface 2a and the bottom surface 2b.

An inlet hole 4b is formed in the center of the upper surface 2a. An inlet hole 4a (not shown) and an inlet hole 4c are formed in each of the side surfaces 2c connected to each other through the upper surface 2a, respectively. A recess portion 2e is provided and an engaging portion 13 is formed in the bottom surface 2b.

The holder section 3 has an extending cylindrical body 3b and a head portion 3a fitted with the recess portion 2e of the top section 2. A discharge portion 10 is formed at the end of the body 3b.

The top section 2 and the holder section 3 are engaged with each other by set screws 14.

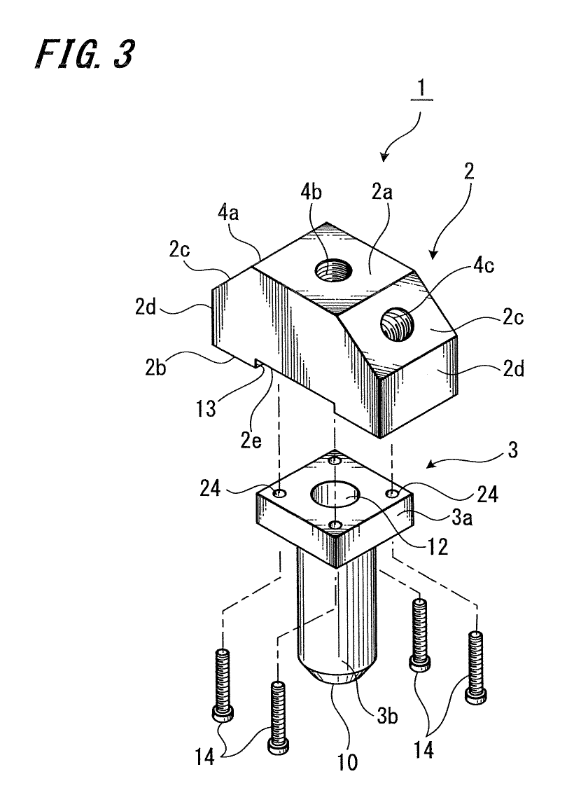

FIG. 3 is an exploded oblique view of the fluid mixer 1 shown in FIG. 2. In FIG. 3, portions corresponding to those of FIG. 2 are indicated by the same symbols, and description of the portions is omitted.

As shown in FIG. 3, the recess portion 2e is formed in the bottom surface 2b of the top section 2 to engage the top section 2 with the holder section 3.

The holder section 3 is formed by the cubic head portion 3a and the cylindrical body 3b formed integrally with the head portion 3a to be extended from the center of the head portion 3a. A fitting hole 12 into which a mixing element described later is to be inserted is formed in the center of the head portion 3a, and screw holes 24 are formed to penetrate into four corners of the head portion 3a.

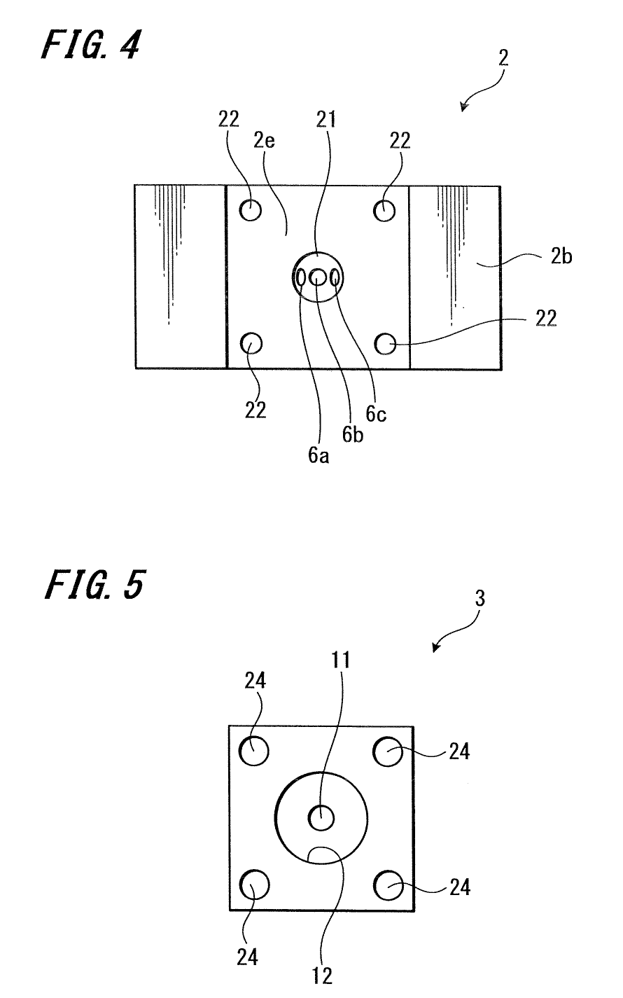

FIG. 4 is a plan view of the top section 2 used in the present embodiment viewed from the side of the bottom surface 2b.

As shown in FIG. 4, the recess portion 2e is formed in a square shape corresponding to the shape of the head portion 3a of the holder section 3. A hemispheric mixing portion 5 as a mixing portion 5 is formed in the center of the recess portion 2e. A passage 6b communicating with the inlet hole 4b formed in the upper surface 2a of the top section 2 is formed in the center of the mixing portion 5. Passages 6a and 6c are formed laterally to the passage 6b to communicate with the inlet holes 4a and 4c formed on each of the side surfaces 2c, respectively. Screw holes 22 into which the tips of the set screws 14 are to be inserted are formed on four corners of the recess portion 2e.

FIG. 5 is a plan view of the holder section 3 used in the present embodiment viewed from the side of the head portion 3a.

As shown in FIG. 5, the head portion 3a of the holder section 3 is formed in a square shape, and the fitting hole 12 into which a mixing element described later is to be inserted is formed in the center of the head portion 3a. A passage 11 is formed in the center of the bottom of the fitting hole 12. The screw holes 24 into which the set screws 14 are to be inserted are formed on four corners of the head portion 3a.

The top section 2 and the holder section 3 are engaged with each other by the set screws 14 so that the head portion 3a of the holder section 3 is fitted with the recess portion 2e of the top section 2. The top section 2 and the holder section 3 are made of a fluororesin.

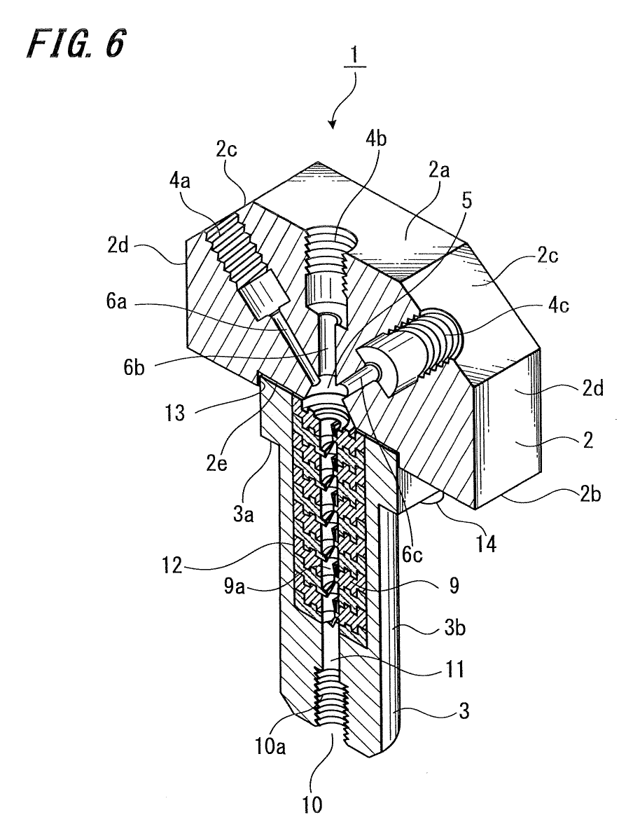

FIG. 6 is an oblique cross-sectional view of a fluid mixer according to a first embodiment of the present invention.

In FIG. 6, portions corresponding to those of FIG. 2 are indicated by the same symbols, and description of the portions is omitted.

As shown in FIG. 6, a mixing portion 5 as a mixing portion is formed in a recess portion 2e formed in a bottom surface 2d of a top section 2. In the present embodiment, the mixing portion 5 is formed to have a volume of approximately 0.1 cc.

In the top section 2, passages 6a, 6b, and 6c are formed to allow the mixing portion 5 to communicate with inlet holes 4a, 4b, and 4c. In the present embodiment, each of the passages 6a, 6b, and 6c is formed to have a diameter of 2.0 mm.

A groove is formed in each of the inlet holes 4a, 4b, and 4c to engage a universal joint member described later with the inlet hole, and the portions of the inlet holes 4a, 4b, and 4c communicate with the passages 6a, 6b, and 6c, respectively.

(1) It should be noted that the head portion may be formed by providing check valve 17 inside the passages 6b. In this case, the check valves used as the universal joint members may not be engaged with the passages 6b.

A fitting hole 12 is formed in a holder section 3 to fit the holder section 3 with a mixing member 9. A plurality of mixing elements 30 having right-twisted and left-twisted spiral blades are inserted into the fitting hole 12 to form the mixing member 9. Specifically, the mixing member 9 is incorporated in the holder section 3. A passage 9a through which a fluid passes is formed in the mixing member 9.

In a body 3b of the holder section 3, a passage 11 is formed to communicate with a passage 9a and a discharge portion 10. A groove 10a is formed in the discharge portion 10 to engage a universal joint member described later with the discharge portion 10.

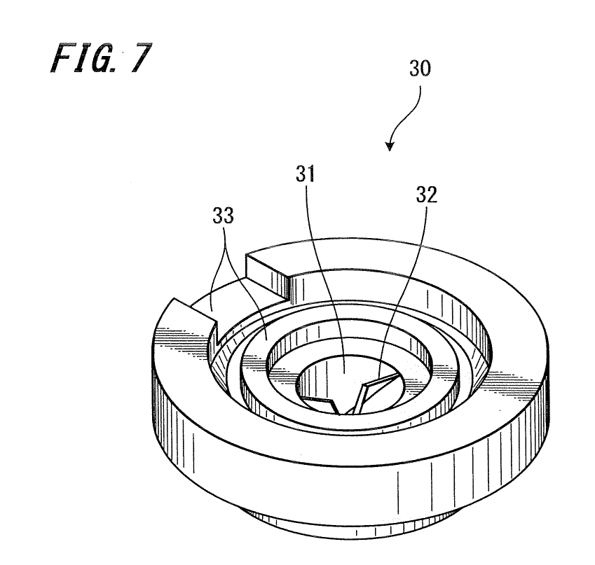

FIG. 7 is an oblique view of a mixing element member that forms the mixing member used in the fluid mixer of the present embodiment.

As shown in FIG. 7, the mixing element 30 as a mixing element member is formed in a disc-like shape, where a plurality of grooves are formed along the outer periphery of the disc to form a recess and projection portion 33. Since the mixing element 30 of the present embodiment may be simply fitted with another mixing element having right-twisted and left-twisted spiral blades using the recess and projection portion 33 formed by a plurality of grooves, the mixing member 9 may be easily produced. The size and length of the mixing member 9 may be appropriately controlled by increasing or decreasing the number of the mixing elements as required.

A passage hole 31 through which a fluid is allowed to pass is formed in the center of the mixing element 30. In the passage hole 31, a divider 32 is formed by two blades, one right-twisted spiral blade and the other left-twisted spiral blade. The passage hole 31 preferably has a diameter of 0.5 mm to 10.0 mm. In the present embodiment, the passage hole is formed to have a diameter of 2.8 mm and an internal volume of about 0.02 ml. The mixing element 30 is made of a fluororesin.

In the center of the mixing member 9 formed by fitting the plurality of mixing elements 30 having right-twisted and left-twisted spiral blades as described above, a passage 9a through which a fluid is allowed to pass is formed by the passage holes 31 included in the mixing elements. According to the mixing element 30 of the present embodiment, the divider 32 is provided in the passage hole 31, so that a fluid shear force in an axial direction may be increased in a laminar flow region and efficiency in mixing different types of fluids may be improved.

As described above, the fluid mixer 1 of the present embodiment is formed so that the inlet holes 4a, 4b, and 4c of the top section 2 communicate with the discharge portion 10 of the holder section 3 through the passages 6a, 6b, and 6c, the mixing portion 5, the passage 9a, and the passage 11.

The mixing portion 5 formed in the top section 2 is placed near the mixing member 9. Specifically, the mixing portion 5 of the present embodiment is placed near the passage hole 31 included in the uppermost element among the plurality of mixing elements 30 forming the mixing member 9.

A mechanism of the fluid mixer 1 of the present embodiment will be described.

First, an epoxy resin as a fluid is injected into the inlet hole 4a, and at the same time a curing agent as a fluid is injected into the inlet hole 4c. The epoxy resin reaches the mixing portion through the passage 6a. The curing agent also reaches the mixing portion 5 through the passage 6c. The epoxy resin and the curing agent are mixed in the mixing portion 5 and then flow into the passage 9a formed in the mixing member 9. A mixed fluid of the epoxy resin and the curing agent flowing into the passage 9a is further divided, moved, superposed, and sheared by the spiral blades provided in each of the mixing elements 30, so that the mixed fluid is further mixed. The mixed fluid mixed in the mixing member 9 is discharged to the outside from the discharge portion 10 through the passage 11. A urethane resin or acrylic resin may be used instead of the epoxy resin.

A cleaning liquid may also be injected into the inlet hole 4b. The cleaning liquid injected in this manner may wash out the mixed fluid of the epoxy resin and the curing agent before the mixed liquid is cured in the mixing portion 5 and passage 9a.

(2) It should be noted that the check valves 17 having an inverted-conical shape may be placed in the contact surface between the edge of the passage 6b and the mixing portion 5 by providing check valve 17 inside the passages 6b. Accordingly, it is possible to prevent a mixing problem which occurs when the cleaning liquid remained in the passage 6b flows into the mixing portion 5 and mixed with the mixed fluid.

A fluid is not necessarily a liquid such as an epoxy resin or a curing agent and may be a gas or powdery particle. Different types of fluids include a combination of liquids of which properties differ from each other, as well as a combination of a liquid and a gas, a combination of a liquid and a powdery particle, and a combination of a gas and a gas.

According to the fluid mixer 1 of the present embodiment, a fluid velocity distribution may be uniformly maintained and fluids may be homogeneously mixed without using stirring power. According to the fluid mixer 1 of the present embodiment, generation of a so-called ribbon or stripe mixing form may be reduced as compared with a fluid mixer of the related art.

According to the fluid mixer of an embodiment according to the present invention, a plurality of passages are formed in the top section 2 and different fluids are respectively supplied to the passages, so that an accurate amount of a fluid may be supplied to each of the passages. Since the passages are separately formed, it is possible to separately control velocities of different types of fluids to be mixed, for example. Accordingly, curing of a fluid in the top section 2 may be prevented by increasing an injection velocity of a curing agent easily cured, for example.

Since fluids may be separately transported through different passages just before the mixing portion 5, the fluids may be mixed in the top section at a reduced distance. This may prevent curing of a fluid in the top section 2 before the fluid reaches the mixing member 9.

According to the fluid mixer of the present embodiment, the mixing portion 5 is placed just before the mixing member 9, different fluids may be mixed in the mixing member 9 right after mixing the fluids in the mixing portion 5, so that a homogeneous mixed fluid may be obtained. Since the mixing portion 5 has a volume of approximately 0.1 cc, a fluid may be resided in the mixing portion 5 in a short time to prevent curing of the fluid in the mixing portion 5.

In the fluid mixer of the present embodiment, all the portions in the fluid mixer to be brought into contact with a fluid (fluid contact portions) are made of a fluororesin. Since all fluids are mixed in the fluid mixer 1, it is possible to prevent contamination of a fluid by inclusion of a floating substance or the like, and there will be no external contamination.

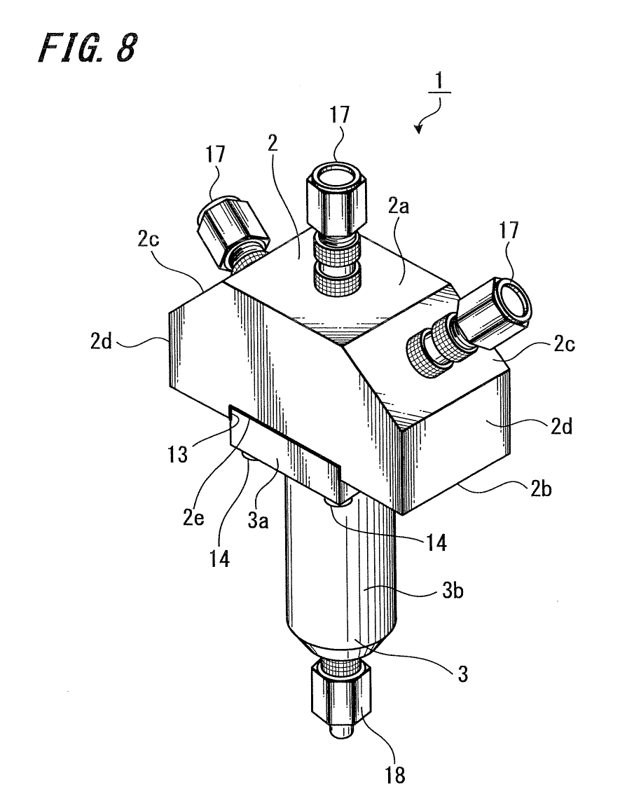

Next, another embodiment of the fluid mixer of the present invention will be described with reference to FIG. 8.

In FIG. 8, portions corresponding to those of FIG. 2 are indicated by the same symbols, and description of the portions is omitted.

As shown in FIG. 8, in the fluid mixer 1 of the present embodiment, check valves 17 as universal joint members are inserted into inlet holes 4a to 4c of a top section 2. The check valves 17 are attached to the top section 2 by engaging grooves formed in the check valves with grooves formed in the inlet holes 4. The check valve 17 has a body made of a fluororesin material such as PCTFE or PFA and a valve element made of Viton. A tube is inserted into the check valve 17 and fixed by screwing, and a specific fluid is injected into the fluid mixer 1. An amount of a fluid injected into the fluid mixer may be controlled by controlling the check valve 17. The check valve may be made of a perfluoro material. A flowmeter or flow control plate may be provided as an orifice member instead of the check valve.

A connector 18 as a universal joint member is inserted into a discharge portion 10 of a holder section 3. The connector 18 is attached to the holder section 3 by engaging a groove formed in the connector with a groove formed in the discharge portion 10. The connector 18 is made of a fluororesin and has excellent chemical resistance. A tube may be inserted into and fixed in the connector 18 by a simple operation, and fluids mixed in the fluid mixer may be supplied to a predetermined place. A tube having various diameters may be connected to the connector by modifying a diameter of the connector.

A device to fix the tube in the universal joint member is not limited to that of the present embodiment. An injection needle or a needle may be fixed on the universal joint member.

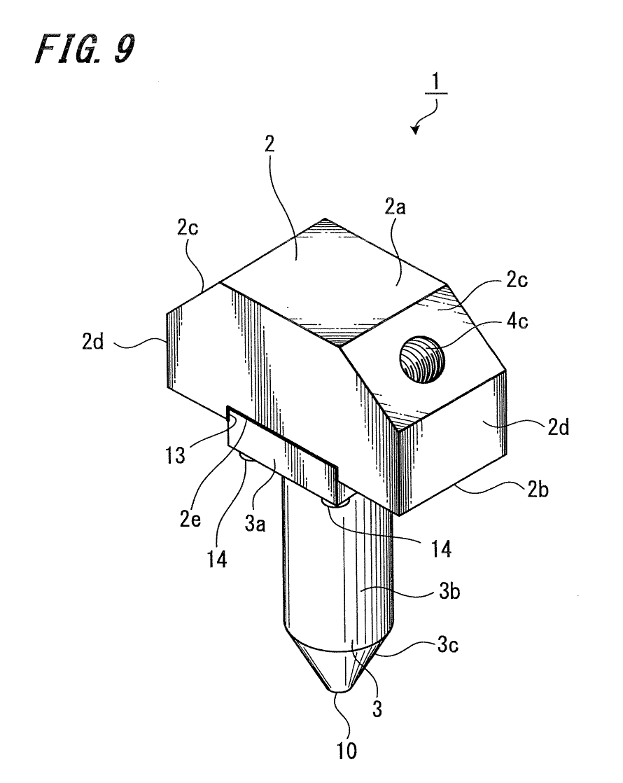

Next, another embodiment of the fluid mixer of the present invention will be described with reference to FIG. 9.

In FIG. 9, portions corresponding to those of FIG. 2 are indicated by the same symbols, and description of the portions is omitted.

As shown in FIG. 9, the fluid mixer differs from the fluid mixer of FIG. 2 in that an inlet hole is not formed in an upper surface 2a of a top section 2 and only inlet holes 4a and 4c are formed on each of side surfaces 2c. A discharge portion 10 is formed in a holder section 3, and a taper 3c is formed at the end of the holder section 3.

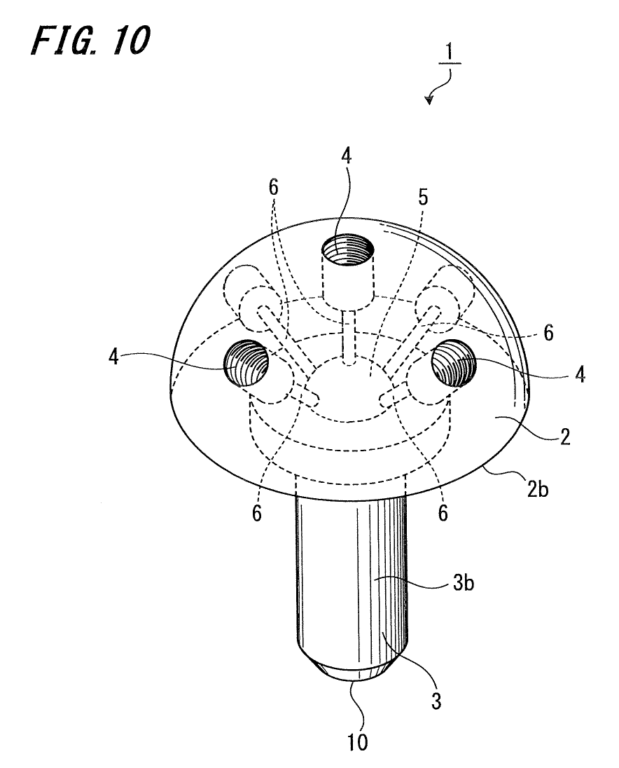

Next, another embodiment of the fluid mixer of the present invention will be described with reference to FIG. 10.

In FIG. 10, portions corresponding to those of FIG. 2 are indicated by the same symbols, and description of the portions is omitted.

As shown in FIG. 10, the fluid mixer differs from the fluid mixer of FIG. 2 in that a top section 2 is hemispherically formed. The top section 2 has five inlet holes 4 formed so that five types of fluids may be supplied at the same time. The top section 2 is hemispherically formed in this manner, so that a plurality of inlet holes may be easily formed at equal intervals with the crown in the center. Five inlet holes are formed in the top section in the present embodiment; however, the number of inlet holes is not limited to five. Three inlet holes may be formed, or seven inlet holes may be formed.

The top section 2 is not necessarily hemispheric and may have a point symmetrical shape with the crown in the center. The top section having a point symmetrical shape may be a polygon having a plurality of planes with inlet holes.

The fluid mixer of an embodiment according to the present invention is not limited to the fluid mixer of each of the aforementioned embodiments, and it is to be understood that various changes and modifications could be effected without departing from the spirit or scope of the present invention in terms of the material or structure, for example. In particular, the shape or material of the top section or holder section forming the fluid mixer is not limited to that of the aforementioned embodiment.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A fluid mixer to mix different fluids, the fluid mixer comprising:
a top section and a holder section,
the top section having a plurality of inlets and a mixing portion communicating with the plurality of inlets, and
the holder section having a discharge portion communicating with the mixing portion through a passage and a mixing member to mix the different fluids in the middle of the passage.

2. The fluid mixer according to claim 1, wherein
the mixing portion is provided near the mixing member.

3. The fluid mixer according to claim 1, wherein
the top section is hemispherically formed.

4. The fluid mixer according to claim 1, wherein
a universal joint member is detachably engaged with the inlet.

5. The fluid mixer according to claim 1 or 2, wherein
a universal joint member is detachably engaged with the discharge portion.

6. The fluid mixer according to claim 1, wherein
the mixing member is formed by a combination of a plurality of mixing element members having an identical structure.

7. The fluid mixer according to claim 6, wherein
the mixing element members each have a passage hole through which the different fluids are allowed to pass and a divider having a spiral shape formed in the passage hole.

8. The fluid mixer according to claim 7, wherein
the passage hole has a diameter of 0.5 mm to 10.0 mm.

9. A mixing element member that forms a mixing member used in a fluid mixer to mix different fluids, the mixing element member comprising:
a passage hole through which the fluids are allowed to pass and a divider having a spiral shape formed in the passage hole.

10. The mixing element member according to claim 9, wherein
the mixing element member has a recess and projection portion to fit the mixing element member with another mixing element member having an identical structure.

11. The mixing element member according to claim 9, wherein
the passage hole has a diameter of 0.5 mm to 10.0 mm.
